(19) United States
(12) Patent Application Publication
(10) Pub. No.: US 2006/0290415 A1
(43) Pub. Date: Dec. 28, 2006

(54) Low-voltage, buffered bandgap reference with selectable output voltage

(76) Inventors: Peter Hazucha, Beaverton, OR (US); Sung T. Moon, Hillsboro, OR (US); Gerhard Schrom, Hillsboro, OR (US); Fabrice Paillet, Hillsboro, OR (US); Tanay Karnik, Portland, OR (US); Vivek De, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/170,559

(22) Filed: Jun. 28, 2005

(51) Int. Cl. G05F 1/10

(52) U.S. Cl. 327/539

(57) ABSTRACT

A temperature-independent voltage reference containing two independent bias circuits powered by the reference voltage, each bias circuit containing components with an exponential dependence of current on voltage and one containing a resistive impedance, and further including voltage dividers and an active component.

### FIELD OF THE INVENTION

Embodiments of the invention relate to temperature independent voltage references. More specifically, embodiments of the invention relate to voltage references that can operate at voltages less than a bandgap voltage.

### BACKGROUND

Temperature-independent voltage references are used in many different applications. For example, they can help ensure stability of oscillators, digital-to-analog converters (DACs) and analog-to-digital converters (ADCs), phase-locked loops (PLLs), linear regulators, DC-DC converters, RF circuits, and body-bias generators. Many prior-art voltage reference designs rely on a combination of elements with differing temperature characteristics. The combination typically results in a reference voltage equal to the semiconductor bandgap voltage (approximately 1.2V for silicon). This voltage can be multiplied to produce higher-valued references.

As microelectronic circuit processing techniques and material purities improve, smaller and more power-efficient circuits can be constructed. However, these smaller circuits often have correspondingly smaller process maximum voltages (“Vₘₐₓ”)—that is, voltages above which the circuit elements will be damaged. In some circuits, the process maximum voltage can be less than the semiconductor bandgap voltage (approximately 1.2V for silicon). Voltage references that can produce a stable, temperature-independent reference of less than the semiconductor bandgap voltage may be useful in combination with these circuits.

FIG. 1 shows a prior-art voltage reference as taught in A Precision Reference Voltage Source by Karel E. Kuijk (IEEE Journal of Solid State Circuits, Vol. SC-8, No. 3, June 1973). Current I₁ through diode 110 and current I₂ through diode 120 and resistor 130 produce voltages V₁ and V₂, respectively; op-amp 140 produces a feedback signal V_{R} that is largely independent of temperature, and substantially equal to the semiconductor bandgap voltage of about 1.2V for silicon. Diodes 110 and 120 may be implemented as the base-emitter junctions of bipolar transistors.

FIG. 2 shows another prior-art voltage reference as taught in A CMOS Bandgap Reference Circuit with Sub-1-V Operation by Hironori Banba et al. (IEEE Journal of Solid-State Circuits, Vol. 34, No. 5, May 1999). This circuit can produce an arbitrarily low reference by adjusting resistor 240, but it has several drawbacks compared to Kuijk's reference. First, it requires three matched current sources (MOSFETs 210, 220 and 230) that, in the deep submicron technologies of modem circuits, are difficult to manufacture due to gate leakage and threshold voltage variation. Second, even if three identical MOSFETs could be made, drain-source voltages across the devices are not equal over a wide temperature range. This causes current mismatch due to a finite drain output impedance. These difficulties can cause a reference variation of as much as 1%. Third, the output of the circuit cannot be loaded—drawing even a small current from the reference at 250 will change the voltage. Fourth, the circuit cannot be used in a shunt configuration (explained below) because it requires a supply voltage 260 that is larger than V_{R}.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIGS. 1 and 2 are prior-art temperature-independent voltage references.

FIG. 3 is a temperature-independent voltage reference according to an embodiment of the invention.

FIG. 4 illustrates the conversion of a circuit into its Thevenin equivalent.

FIG. 5 shows the two independent bias circuits of an embodiment of the invention and their Thevenin equivalent circuits.

FIG. 6 shows embodiments of the invention connected in series and shunt configurations.

FIG. 7 shows block diagrams of four broader systems that can benefit from an embodiment of the invention.

### DETAILED DESCRIPTION

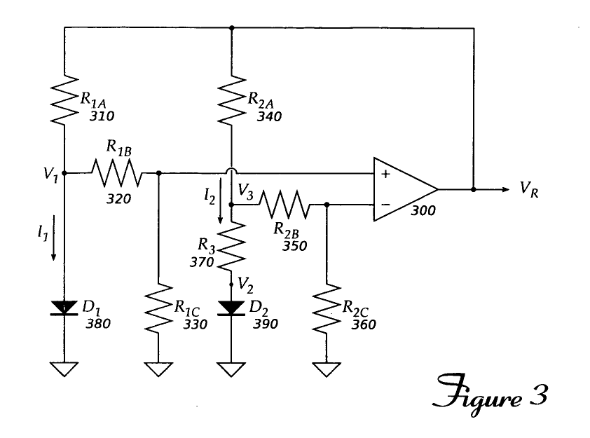

FIG. 3 shows the general form of a circuit according to an embodiment of the invention. The circuit can be used as a precision voltage reference and can operate from a supply voltage below 1.2V, or above 1.2V as long as the maximum voltage rating on the devices is not exceeded. In fact, the supply voltage can be as low as one forward diode voltage, which is about 0.8V for a silicon diode, but can be much lower for a Schottky diode or diodes manufactured from materials other than silicon. The circuit of FIG. 3 is analyzed in the following paragraphs.

The circuit uses one operational amplifier 300, up to seven resistors (R_{1A} 310, R_{1B} 320, R_{1C} 330, R_{2A} 340, R_{2B} 350, R_{2C} 360, R₃ 370), and two components with an exponential dependency of current on voltage (“exponential I(V) characteristic”), shown as diodes D₁ 380 and D₂ 390. Resistors R_{1A} 310, R_{1B} 320 and R_{1C} 330 operate to bias diode D₁ 380 at a first point of its range, while resistors R_{2A} 340, R_{2B} 350, R_{2C} 360 and R₃ 370 bias diode D₂ 390 at a second point of its range. Resistors R_{1B} 320 and R_{1C} 330 form a voltage divider to produce a voltage proportional to V₁, the voltage across D₁. Resistors R_{2B} 350 and R_{2C} 360 form a voltage divider to produce a voltage proportional to V₃, the voltage across D₂ and R₃. The op amp 300 is an active component that compares the voltages of the two voltage dividers and produces an output signal that, because of the feedback loop in the circuit, is a temperature-independent reference voltage whose value is set according to the selection of the resistors. As shown in FIG. 3, the two bias circuits are each powered by the reference voltage, and operate independently of each other, since no path exists for current to flow from one to the other. In various embodiments, diodes D₁ and D₂ may be implemented as actual P-N junction diodes, as the base-emitter junction of a bipolar transistor, or as another component with an exponential I(V) characteristic. The generic term “diode” will be used to refer to these circuit elements. In some embodiments, a “string” of several diodes or base-emitter junctions may be formed in series, instead of a single diode or transistor.

The circuit operates on the principle that if two diodes are biased at different current densities with a constant ratio, then the difference between voltages across the two diodes is proportional to absolute temperature (“PTAT”). If the current densities are also PTAT, then the forward voltage across each diode is inversely proportional to absolute temperature (“IPTAT”). A properly-selected, weighted sum of the IPTAT diode voltage and the PTAT difference of diode voltages has a zero temperature coefficient (ZTC) to the first order. Such a weighted sum is known to be substantially equal to the bandgap voltage V_{G}, but if additional degrees of freedom are provided (by, for example, the voltage dividers containing resistors R_{1B} 320 and R_{1C} 330, and R_{2B} 350 and R_{2C} 360) the weighted sum can be adjusted to a desired value, not necessarily equal to the bandgap voltage, by adjusting the ratios between voltage-divider resistors. The adjusted, weighted sum retains its temperature independence, and, since it is produced as a feedback signal from op amp 300 (which compares scaled voltages proportional to V₁ and V₃), it is a low-impedance source that can be loaded without ill effects.

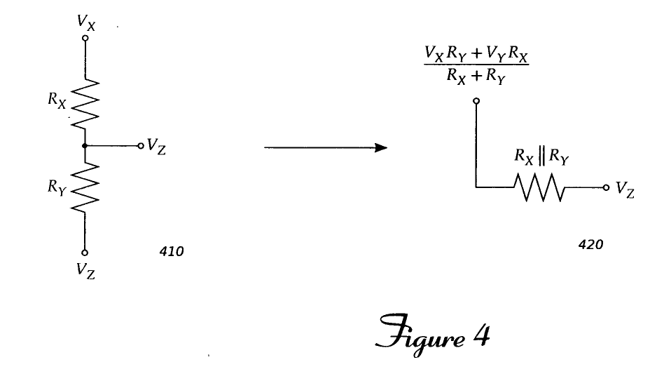

A simplified Thevenin-equivalent of the circuit shown in FIG. 3 is useful in deriving a quantitative description of that circuit's operation. FIG. 4 provides a simple illustration of a Thevenin equivalent. Resistive voltage divider R_{X}, R_{Y} is connected between voltage potentials V_{X} and V_{Y} at element 410. According to Thevenin's theorem, the divider can be replaced by a voltage source and output impedance satisfying the following equation:

$$\begin{matrix}{I}_{Z} = \frac{{V}_{X} - {V}_{Z}}{{R}_{X}} + \frac{{V}_{Y} - {V}_{Z}}{{R}_{Y}} \\ = \frac{\frac{{V}_{X} {R}_{Y} + {V}_{Y} {R}_{X}}{{R}_{X} + {R}_{Y}} - {V}_{Z}}{\frac{{R}_{X} {R}_{Y}}{{R}_{X} + {R}_{Y}}} \\ = \frac{\frac{{V}_{X} {R}_{Y} + {V}_{Y} {R}_{X}}{{R}_{X} + {R}_{Y}} - {V}_{Z}}{{R}_{X} \vert \vert {R}_{Y}}\end{matrix} \qquad ( 1 )$$

The Thevenin equivalent voltage source and output impedance are shown as element 420.

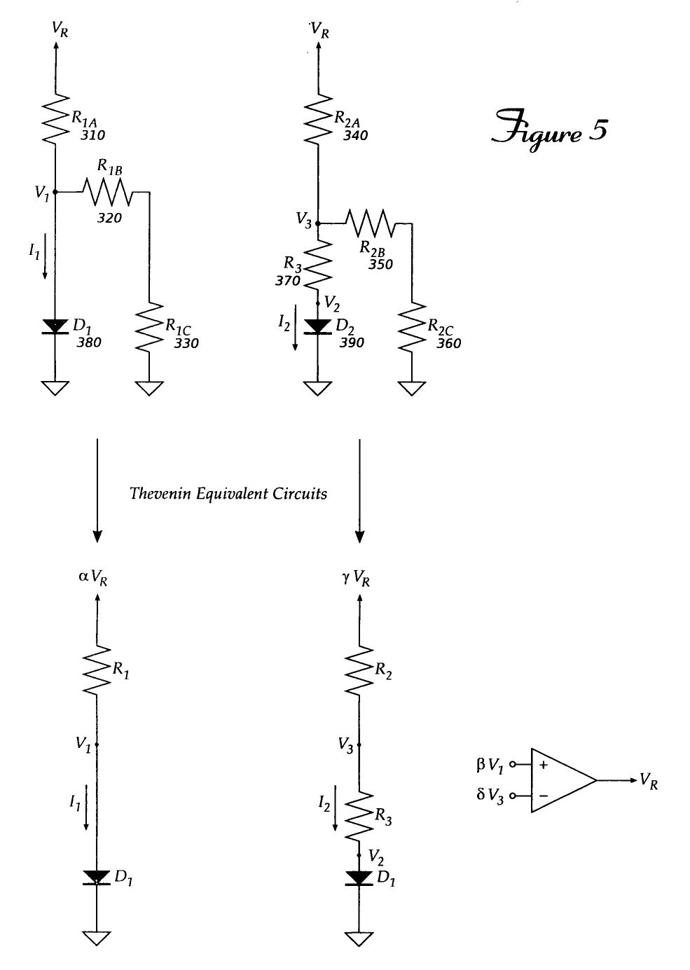

Since resistors R_{1A} and (R_{1B}+R_{1C}) form a voltage divider with output V₁, and resistors R_{2A} and (R_{2B}+R_{2C}) form a voltage divider with output V₃, these can be replaced with their equivalent circuits as shown in FIG. 5. In making the transformation, amplifier inputs are assumed not to load the R_{1B}+R_{1C} and R_{2B}+R_{2C} legs of the voltage dividers, and the following definitions are used to simplify the equations:

$$\begin{matrix}{R}_{1} = {R}_{1 A} \vert \vert ( {R}_{1 B} + {R}_{1 C} ) = \frac{{R}_{1 A} * ( {R}_{1 B} + {R}_{1 C} )}{{R}_{1 A} + {R}_{1 B} + {R}_{1 C}} & ( 2 ) \\ {R}_{2} = {R}_{2 A} \vert \vert ( {R}_{2 B} + {R}_{2 C} ) = \frac{{R}_{2 A} * ( {R}_{2 B} + {R}_{2 C} )}{{R}_{2 A} + {R}_{2 B} + {R}_{2 C}} & ( 3 ) \\ α = \frac{{R}_{1 B} + {R}_{1 C}}{{R}_{1 A} + {R}_{1 B} + {R}_{1 C}} & ( 4 ) \\ β = \frac{{R}_{1 C}}{{R}_{1 B} + {R}_{1 C}} & ( 5 ) \\ γ = \frac{{R}_{2 B} + {R}_{2 C}}{{R}_{2 A} + {R}_{2 B} + {R}_{2 C}} & ( 6 ) \\ δ = \frac{{R}_{2 C}}{{R}_{2 B} + {R}_{2 C}} & ( 7 )\end{matrix}$$

With the help of these definitions and the Thevenin-equivalent circuits shown in FIG. 5, conditions can be derived for resistor values that will guarantee proper operation of the circuit in FIG. 3.

If we define

$${V}_{T} = \frac{nkT}{q} \qquad ( 8 )$$

where n is the ideality factor of a diode (n=1 for an ideal diode, but is somewhat larger than 1 for actual diodes), then current through diode D₁ is given by

$$\begin{matrix}{I}_{1} = {I}_{S 1} * exp ( \frac{{V}_{1}}{{V}_{T}} ) = {I}_{O 1} * exp ( \frac{- {V}_{G}}{{V}_{T}} ) * exp ( \frac{{V}_{1}}{{V}_{T}} ) & ( 9 ) \\ {I}_{O 1} = {A}_{1} * D * {T}^{η} & ( 10 )\end{matrix}$$

where A₁ is the area of diode D₁, V_{G} is the bandgap voltage, and D and η are process-dependent constants. Similarly we can write for the current through diode D₂:

$$\begin{matrix}{I}_{2} = {I}_{S 2} * exp ( \frac{{V}_{2}}{{V}_{T}} ) = {I}_{O 2} * exp ( \frac{- {V}_{G}}{{V}_{T}} ) * exp ( \frac{{V}_{2}}{{V}_{T}} ) & ( 11 ) \\ {I}_{O 2} = {A}_{2} * D * {T}^{η} & ( 12 ) \\ {A}_{2} = N * {A}_{1} & ( 13 )\end{matrix}$$

From the diode current equations above we can write voltages V₁ and V₂ as:

$$\begin{matrix}{V}_{1} = {V}_{G} + {V}_{T} ln ( \frac{{I}_{1}}{{I}_{O 1}} ) & ( 14 ) \\ {V}_{2} = {V}_{G} + {V}_{T} ln ( \frac{{I}_{2}}{{I}_{O 2}} ) & ( 15 )\end{matrix}$$

and the difference between these voltages as:

$${V}_{1} - {V}_{2} = {V}_{T} ln ( \frac{{I}_{O 2}}{{I}_{O 1}} * \frac{{I}_{1}}{{I}_{2}} ) \qquad ( 16 )$$

From Ohm's law, we can calculate currents I₁ and I₂:

$$\begin{matrix}{I}_{1} = \frac{α * {V}_{R} - {V}_{1}}{{R}_{1}} & ( 17 ) \\ {I}_{2} = \frac{γ * {V}_{R} - {V}_{3}}{{R}_{2}} & ( 18 )\end{matrix}$$

and write their ratio as:

$$\frac{{I}_{1}}{{I}_{2}} = \frac{{R}_{2}}{{R}_{1}} * \frac{α * {V}_{R} - {V}_{1}}{γ * {V}_{R} - {V}_{3}} \qquad ( 19 )$$

Because of the feedback loop, the amplifier operates to keep
β*V₁=δ*V₃ (20)
so we can write:

$$\frac{{I}_{1}}{{I}_{2}} = \frac{{R}_{2}}{{R}_{1}} * \frac{δ}{β} \frac{α * {V}_{R} - {V}_{1}}{γ \frac{δ}{β} * {V}_{R} - {V}_{1}} \qquad ( 21 )$$

To remove the temperature- and voltage-dependency of the ratio of I₁ and I₂, we set

$$α = γ \frac{δ}{β} \qquad ( 22 )$$

which gives:

$$\frac{{I}_{1}}{{I}_{2}} = \frac{{R}_{2}}{{R}_{1}} * \frac{δ}{β} = \frac{{R}_{2}}{{R}_{1}} * \frac{α}{γ} . \qquad ( 23 )$$

From the definitions of I_{O1} and I_{O2}, we obtain

$$\frac{{I}_{O 2}}{{I}_{O 1}} = \frac{{A}_{2}}{{A}_{1}} = N \qquad ( 24 )$$

After substitution for ratios of currents, we obtain for the diode voltage difference

$${V}_{1} - {V}_{2} = {V}_{T} ln ( \frac{{I}_{O 2}}{{I}_{O 1}} * \frac{{I}_{1}}{{I}_{2}} ) = {V}_{T} * ln ( N * \frac{{R}_{2}}{{R}_{1}} * \frac{α}{γ} ) \qquad ( 25 )$$

From Ohm's law,

$$\begin{matrix}{I}_{2} = \frac{{V}_{3} - {V}_{2}}{{R}_{3}} = \frac{\frac{β}{δ} * {V}_{1} - {V}_{2}}{{R}_{3}} = \frac{\frac{γ}{α} * {V}_{1} - {V}_{2}}{{R}_{3}} & ( 26 ) \\ Then , & \\ α * {V}_{R} = {V}_{1} + {R}_{1} * {I}_{1} = {V}_{1} + {R}_{1} * \frac{{R}_{2}}{{R}_{1}} * \frac{α}{γ} * {I}_{2} = {V}_{1} + {R}_{2} * \frac{α}{γ} * {I}_{2} & ( 27 ) \\ α * {V}_{R} = {V}_{1} + {R}_{2} * \frac{α}{γ} * \frac{\frac{γ}{α} * {V}_{1} - {V}_{2}}{{R}_{3}} & ( 28 ) \\ α * {V}_{R} = {V}_{1} * [ 1 + \frac{{R}_{2}}{{R}_{3}} * ( 1 - \frac{α}{γ} ) ] + \frac{{R}_{2}}{{R}_{3}} * \frac{α}{γ} * ( {V}_{1} - {V}_{2} ) & ( 29 ) \\ and & \\ {V}_{R} = {V}_{1} * [ \frac{1}{α} + \frac{{R}_{2}}{{R}_{3}} * ( \frac{1}{α} - \frac{1}{γ} ) ] + \frac{{R}_{2}}{{R}_{3}} * \frac{1}{γ} * ( {V}_{1} - {V}_{2} ) . & ( 30 )\end{matrix}$$

After substituting for V₁−V₂ into V_{R}, we obtain

$${V}_{R} = \begin{matrix}{V}_{ 1} * [ \frac{1}{ α} + \frac{ {R}_{ 2}}{ {R}_{ 3}} * ( \frac{1}{ α} - \frac{1}{ γ} ) ] + \\ {V}_{ T} * \frac{ {R}_{ 2}}{ {R}_{ 3}} * \frac{1}{ γ} * ln ( N * \frac{ {R}_{ 2}}{ {R}_{ 1}} * \frac{α}{ γ} )\end{matrix} \qquad ( 31 )$$

Continuing, we define constants

$$\begin{matrix}K = \frac{1}{α} + \frac{{R}_{2}}{{R}_{3}} * ( \frac{1}{α} - \frac{1}{γ} ) & ( 32 ) \\ L = \frac{{R}_{2}}{{R}_{3}} * \frac{1}{γ} * ln ( N * \frac{{R}_{2}}{{R}_{1}} * \frac{α}{γ} ) & ( 33 ) \\ and & \\ H = \frac{L}{K} & ( 34 )\end{matrix}$$

Then:
V_{R}=K*V₁+L*V_{T}=K*(V₁+V_{T}*H) (35)

Note that K, L, and H do not depend on temperature because they are only functions of resistor ratios. If a sum of a forward diode voltage and a voltage PTAT exhibits ZTC, then this sum is substantially equal to the bandgap voltage V_{G}. According to the last equation, ZTC can be achieved by a proper selection of resistor values and diode ratios that enter into H. In addition, the reference voltage V_{R} is substantially equal to K*V_{G}. Depending on the value of K, the reference voltage can be lower than, equal to, or larger than the bandgap voltage V_{G}.

With this complete analysis of the circuit of FIG. 3 in hand, we consider several embodiments of the circuit, characterized by the values of α, β, γ and δ, which in turn depend upon the values of R_{1A}, R_{1B}, R_{1C}, R_{2A}, R_{2B} and R_{2C} as specified in the definitions above.

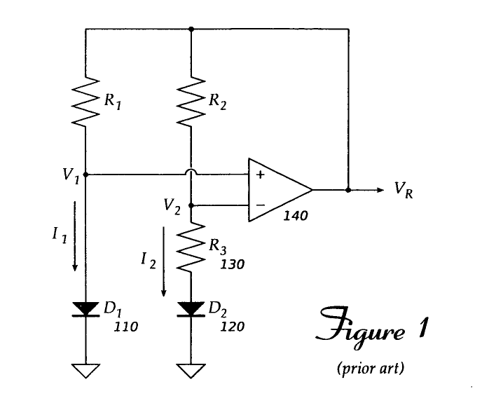

It is interesting to note that if α=β=γ=δ=1, then the equations above describe Kuijk's circuit as shown in FIG. 1. The tapped dividers R_{1B}, R_{1C} and R_{2B}, R_{2C} can be eliminated so that R₁=R_{1A} and R₂=R_{2A}. The reference voltage is given by

$${V}_{R} = {V}_{1} + {V}_{T} * \frac{{R}_{2}}{{R}_{3}} * ln ( N * \frac{{R}_{2}}{{R}_{1}} ) \qquad ( 36 )$$

The condition for ZTC is

$$\begin{matrix}0 = ln ( \frac{{I}_{1 R}}{{I}_{O 1 R}} ) + 1 - η - ϑ + H & ( 37 ) \\ where & \\ H = \frac{{R}_{2}}{{R}_{3}} * ln ( N * \frac{{R}_{2}}{{R}_{1}} ) & ( 38 )\end{matrix}$$

This leads to a second-order temperature dependency

$${V}_{R} = {V}_{G} + {V}_{T} * [ ( η - 1 ) * ( 1 - ln ( \frac{T}{{T}_{R}} ) ) + ϑ - ln ( \frac{{R}_{1}}{{R}_{1 R}} ) ] \qquad ( 39 )$$

so the nominal reference voltage is substantially equal to the bandgap voltage. This provides a useful check of the correctness of the preceding derivation of circuit equations.

In an embodiment of the invention, 0<α=γ<1 and 0<β=δ·1. To obtain the lowest sensitivity to the amplifier offset, one should set β=δ=1. In this case, divider taps for the amplifier inputs are not needed; R_{1B} and R_{1C}, and R_{2B} and R_{2C}, can be combined. In other cases it may be desirable to lower the common mode voltage of the amplifier inputs. In those cases, values for β and δ less than 1 can be used despite the resulting increased offset sensitivity.

The reference voltage for this embodiment is given by

$${V}_{R} = \frac{1}{α} * [ {V}_{1} + {V}_{T} * \frac{{R}_{2}}{{R}_{3}} * ln ( N * \frac{{R}_{2}}{{R}_{1}} ) ] \qquad ( 40 )$$

The condition for ZTC is

$$\begin{matrix}0 = ln ( \frac{{I}_{IR}}{{I}_{OIR}} ) + 1 - η - ϑ + H \\ where & ( 41 ) \\ H = \frac{{R}_{2}}{{R}_{3}} * ln ( N * \frac{{R}_{2}}{{R}_{1}} ) & ( 42 )\end{matrix}$$

This leads to the second-order temperature dependency

$${V}_{R} = \frac{1}{α} * \{ {V}_{G} + {V}_{T} * [ ( η - 1 ) * ( 1 - ln ( \frac{T}{{T}_{R}} ) ) + ϑ - ln ( \frac{{R}_{1}}{{R}_{1 R}} ) ] \} \qquad ( 43 )$$

Because 0<α<1, the nominal reference voltage in the second embodiment can be substantially larger than the bandgap voltage.

In another embodiment, 0<γ<α<1, 0<δ≦1, and β=δ*γ/α. Again, offset sensitivity can be minimized if δ=1, although values of δ<1 can lower the common mode voltage. The reference voltage of this embodiment is given by

$$\begin{matrix}{V}_{R} = K * {V}_{1} + L * {V}_{T} = K * ( {V}_{1} + {V}_{T} * H ) \\ where & ( 44 ) \\ K = \frac{1}{α} * [ 1 + \frac{{R}_{2}}{{R}_{3}} * ( 1 - \frac{α}{γ} ) & ( 45 ) \\ L = \frac{1}{α} * \frac{{R}_{2}}{{R}_{3}} * \frac{α}{γ} * ln ( N * \frac{{R}_{2}}{{R}_{1}} * \frac{α}{γ} ) \\ and & ( 46 ) \\ H = \frac{L}{K} & ( 47 )\end{matrix}$$

For properly selected values of α, β, γ and δ, we can obtain K<1. Constants K and L contain four independent parameters: 1/α, α/γ, R₂/R₃ and N*R₂/R₁. The latter parameter determines the sensitivity of the bandgap core and should be as large as practically achievable. The maximum value is usually limited by the diode I-V characteristic to less than about 100. The remaining three parameters can be chosen to satisfy two conditions: the desired value of the reference voltage V_{R} and ZTC. This leaves freedom to arbitrarily choose one of the three parameters.

It turns out that the residual temperature dependency (after achieving ZTC at the desired temperature T_{R}) is smallest when α is close to 1. If the values of resistors R_{1B} and R_{1C} are much larger than the value of R_{1A}, they may be costly to implement and the resistor ratios may be difficult to match. Without too much degradation in temperature sensitivity, it may be more practical to choose a between about 0.9 and 0.95. Then parameters α/γ, R₂/R₃ can be found as solutions of a system of two equations: one for the desired K<1 and the other for the ZTC condition.

Because 0<K<1, the nominal reference voltage can be substantially lower than the bandgap voltage.

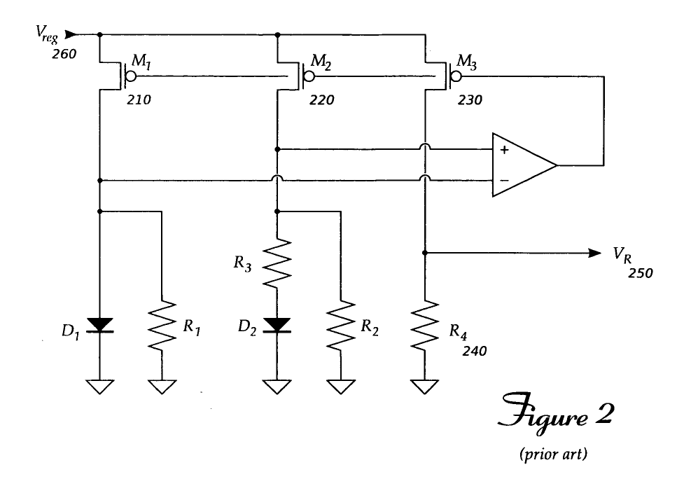

By way of comparison with the prior art circuits shown in FIGS. 1 and 2, embodiments of the current invention can generate arbitrary reference voltages, both larger and smaller than the bandgap voltage. Kuijk's circuit can only produce a reference equal to the bandgap voltage. Banba's circuit can produce an arbitrary reference voltage, but the reference cannot supply any current, and the circuit requires a regulated voltage larger than the reference voltage to operate. Also, Banba requires matched transistors, which are difficult to fabricate. Embodiments of the current invention require no matching of transistors beyond that required for a low-offset operational amplifier (a requirement common to all the circuits).

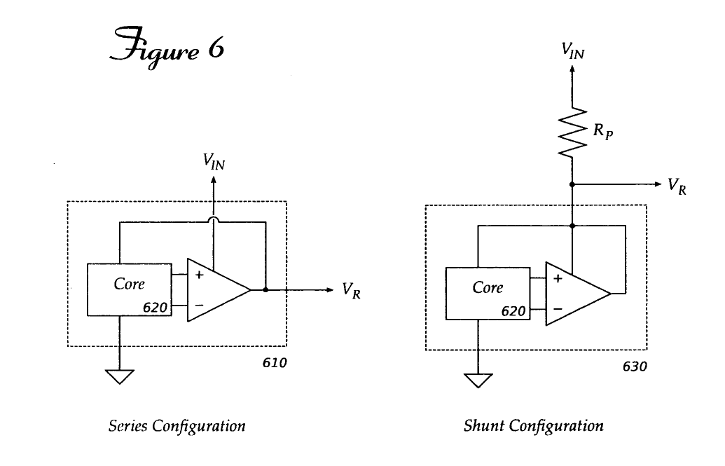

Embodiments of the current invention can be used in the configurations shown in FIG. 6. Element 610 shows the circuit in a series configuration (“core” 620 represents the diode and resistor network shown in FIG. 3). In series mode, Vᵢₙ powers the amplifier only; the core is powered from the reference-voltage output of the amplifier. Since the reference voltage appears at the output of an amplifier, it can be loaded and/or drive other circuits without affecting the reference's stability.

Element 620 shows the circuit in a shunt configuration. This two-terminal circuit can be powered by any voltage Vᵢₙ greater than V_{R}; any excess voltage appears across the pull-up resistor R_{P}. In particular, when the amplifier is powered from V_{R} itself, as shown, it is possible to safely operate the circuit from a voltage larger than the maximum process voltage (Vₘₐₓ). For a CMOS technology, Vₘₐₓ is given by hot carrier degradation, oxide breakdown and tunneling, or the maximum reverse diode voltage. Safe operation at elevated voltage Vᵢₙ is possible because in a shunt configuration, the output reference voltage V_{R} is also the maximum voltage applied to the components of the reference circuit. The circuit will operate reliably as long as the reference voltage is set to a value less than or equal to Vₘₐₓ, and (as discussed earlier) Vₘₐₓ can be less than V_{G}.

A further application of the circuit capitalizes on the fact that the voltage across resistor R₃ is proportional to the absolute temperature. Because of this property, the circuit can also be used as a self-biased linear temperature sensor, with the voltage across resistor R₃ providing the linear temperature signal.

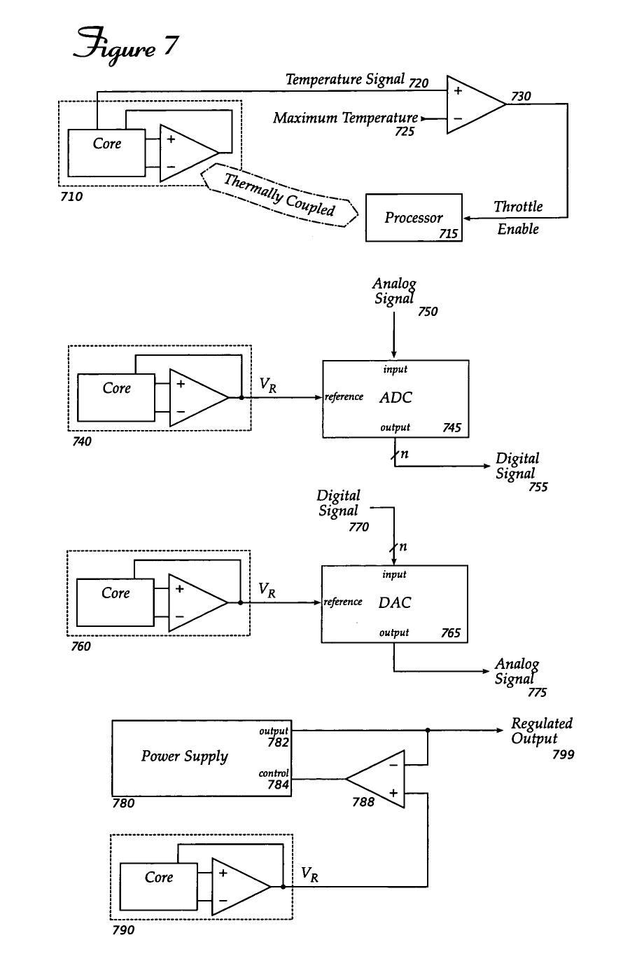

FIG. 7, element 710 shows an embodiment of the invention operating as a temperature sensor. Such a sensor may be fabricated on or near a substrate containing another circuit such as a digital processor 715 (e.g. a programmable processor or a digital signal processor) so that it is thermally coupled with the processor. The temperature sensor can be used to monitor the temperature of the digital processor, providing a temperature signal 720 that can be compared with a maximum temperature 725 by a device such as comparator 730, and may trigger a throttling mechanism such as a clock divider if the processor's temperature exceeds a safe value. In this application, an embodiment of the invention can help prevent thermal damage to a processor operating in a hostile environment (high ambient temperature, inadequate cooling, excess supply voltage, sustained duty cycle, etc.)

FIG. 7, element 740 shows an embodiment of the invention used as a temperature-independent voltage reference, with its output signal providing a reference value for analog-to-digital converter (“ADC”) 745. ADCs can convert an analog input signal 750 at the converter's input into a digital value such as n-bit digital signal 755 presented at the converter's output. A reference input supplied by a temperature-independent voltage reference, permits the digital value to be calibrated to a known absolute voltage value. In a complementary application, an embodiment of the invention 760 can provide a reference value for use by a digital-to-analog converter (“DAC”) 765. A DAC can convert a digital value (for example, an n-bit binary number 770) into an analog voltage or current such as analog signal 775. By incorporating a stable reference voltage from an embodiment of the invention, the DAC system can produce an analog signal that is calibrated to a known absolute voltage.

Embodiments of the invention may also find applications in regulated power supplies. For example, power supply 780 provides current from its output 782. Control input 784 may be used to adjust the voltage at output 782. An embodiment of the invention shown as element 790 can supply a temperature independent reference voltage V_{R} to comparator 788, which compares the reference voltage to the output voltage and produces an appropriate feedback signal to cause the output voltage to match the reference voltage. This feedback loop regulates the output voltage to produce regulated output 799.

The embodiments of the present invention have been described largely in terms of specific proportional relationships between the values of certain components. However, those of skill in the art will recognize that other proportional relationships can produce temperature-insensitive voltage references and self-biased linear temperature sensors with other characteristics. Such variations are understood to be apprehended according to the following claims.

We claim:

1. An apparatus comprising:
a first bias circuit to bias a first component with an exponential dependency of current on voltage (“exponential I(V) characteristic”) at a first point of its range;
a second, independent bias circuit to bias a second component with an exponential I(V) characteristic at a second point of its range, the first point being different than the second point;
a resistive impedance in series with the second component;
a first voltage divider to produce a first voltage proportional to a voltage across the first component;
a second voltage divider to produce a second voltage proportional to a sum of a voltage across the second component and a voltage across the resistive impedance; and
an active component to compare the first voltage and the second voltage and to produce a reference voltage; wherein in operation a current through each voltage divider is greater than zero, and
the bias circuits are powered by the reference voltage.

2. The apparatus of claim 1 wherein the first and second components are diodes.

3. The apparatus of claim 1 wherein the first and second components are bipolar transistors.

4. The apparatus of claim 1 wherein the first bias circuit comprises a first resistor in series with the first component and the second bias circuit comprises a second resistor in series with the second component and the resistive impedance.

5. The apparatus of claim 4 wherein the first voltage divider comprises a first divider resistor in series with a second divider resistor; and the second voltage divider comprises a third divider resistor in series with a fourth divider resistor.

6. The apparatus of claim 5 wherein:
α is a ratio between a sum of the first divider resistor and the second divider resistor; and a sum of the first resistor, the first divider resistor and the second divider resistor;
β is a ratio between the, second divider resistor and a sum of the first divider resistor and the second divider resistor;
γ is a ratio between a sum of the third divider resistor and the fourth divider resistor; and a sum of the second resistor, the third divider resistor and the fourth divider resistor; and
δ is a ratio between the third divider resistor and a sum of the third divider resistor and the fourth divider resistor; where
0<α=γ<1 and 0<β=δ·1

7. The apparatus of claim 5 wherein:
α is a ratio between a sum of the first divider resistor and the second divider resistor; and a sum of the first resistor, the first divider resistor and the second divider resistor;
β is a ratio between the second divider resistor and a sum of the first divider resistor and the second divider resistor;
γ is a ratio between a sum of the third divider resistor and the fourth divider resistor; and a sum of the second resistor, the third divider resistor and the fourth divider resistor; and
δ is a ratio between the third divider resistor and a sum of the third divider resistor and the fourth divider resistor; where
0<γ<α<1; 0<δ·1; and β=δ*γ/α

8. The apparatus of claim 1 wherein the reference voltage is not equal to a bandgap voltage.

9. The apparatus of claim 1 wherein the reference voltage is less than a bandgap voltage.

10. The apparatus of claim 1 wherein the reference voltage is greater than a bandgap voltage.

11. The apparatus of claim 5 wherein:
α is a ratio between a sum of the first divider resistor and the second divider resistor; and a sum of the first resistor, the first divider resistor and the second divider resistor;
γ is a ratio between a sum of the third divider resistor and the fourth divider resistor; and a sum of the second resistor, the third divider resistor and the fourth divider resistor;
R2 is a Thevenin equivalent resistance of the second bias circuit and the second voltage divider;
R3 is a resistance of the resistive impedance in series with the second component; and
$$K is \frac{1}{α} + \frac{{R}_{2}}{{R}_{3}} * ( \frac{1}{α} - \frac{1}{γ} ) ;$$
the reference voltage being substantially equal to a product of K and a bandgap voltage.

12. The apparatus of claim 1 wherein a maximum permissible voltage for the active component does not exceed a bandgap voltage.

13. The apparatus of claim 1 wherein:
a maximum permissible voltage for the active component exceeds a bandgap voltage; and
the reference voltage is less than the bandgap voltage.

14. The apparatus of claim 1 wherein the reference voltage is less than 1.2 volts.

15. The apparatus of claim 8 wherein the first component with an exponential I(V) characteristic is formed upon a silicon substrate.

16. A method comprising:
biasing a first component with an exponential dependency of current on voltage (“exponential I(V) characteristic”) from a reference voltage at a first current density;
biasing a second component with an exponential I(V) characteristic from the reference voltage at a second current density, the first density being different than the second density and the first density and the second density having a constant ratio;
developing a first voltage proportional to a voltage across the first component;
developing a second voltage proportional to the second current density;
developing a third voltage proportional to a sum of the second voltage and a voltage across the second component;
adjusting the first current density and the second current density by altering the reference voltage so that the first voltage and the third voltage are substantially equal.

17. The method of claim 16, wherein the reference voltage is greater than a bandgap voltage.

18. The method of claim 16, wherein the reference voltage is less than a bandgap voltage.

19. The method of claim 16, wherein the reference voltage is a low-impedance feedback signal.

20. The method of claim 16 wherein the second voltage is proportional to an absolute temperature.

21. A system comprising:
a temperature-independent reference voltage generator to produce a reference voltage less than a bandgap voltage; and
a circuit having a process maximum voltage less than the bandgap voltage to use the reference voltage.

22. The system of claim 21 wherein the reference voltage generator operates in a series configuration.

23. The system of claim 21 wherein the reference voltage generator operates in a shunt configuration.

24. The system of claim 21 wherein the reference voltage generator comprises a resistor, wherein
a voltage across the resistor is proportional to absolute temperature;
the system to operate as a self-biased linear temperature sensor.

25. The system of claim 24 further comprising a digital processor, wherein:
a throttling mechanism of the digital processor is activated if a temperature detected by the temperature sensor exceeds a predetermined value.

26. The system of claim 21 further comprising a converter that is one of an analog-to-digital converter (“ADC”) and a digital-to-analog converter (“DAC”), wherein:
the converter uses the reference voltage to calibrate a conversion of a first signal to a second signal.

27. The system of claim 21 further comprising a power supply and a comparator, wherein:
the comparator is to compare an output of the power supply and the reference voltage to produce a feedback signal; and
the power supply is to adjust its operation in response to the feedback signal so that its output becomes substantially equal to the reference voltage.
